(19) United States
(12) Patent Application Publication
(10) Pub. No.: US 2006/0085319 A1
(43) Pub. Date: Apr. 20, 2006

(54) Methods and apparatus for routing options orders

(76) Inventors: Rishi Nangalia, New York, NY (US); Donald E. Marigliano, Rockville Centre, NY (US)

Correspondence Address: BUCKLEY, MASCHOFF, TALWALKAR LLC, 5 ELM STREET, NEW CANAAN, CT, 06840, US

(21) Appl. No.: 10/968,587

(22) Filed: Oct. 19, 2004

(51) Int. Cl. G06Q 40/00

(52) U.S. Cl. 705/37

(57) ABSTRACT

An options trading system may include a routing system that receives an options trading order from a customer and divides the customer order into secondary orders. Each of the secondary orders may be sent to a respective securities exchange for execution. The size of some or all of the secondary orders may be determined on the basis of a published automatic execution (“auto ex”) order size for each exchange for the option in question. For example, the customer order may be divided into four secondary orders each of which matches the respective auto ex size for the respective exchange for the option in question, plus a fifth secondary order that exceeds the auto ex size for the respective exchange for the option in question.

### FIELD

The present invention relates to systems, methods, apparatus, computer program code and means for routing transactions. More particularly, embodiments of the present invention relate to systems, methods, apparatus, computer program code and means for routing transactions involving options.

### BACKGROUND

In the United States, exchange-trading of options has existed in a standardized, regulated marketplace since the 1970's. An option is essentially a contract giving a buyer the right, but not the obligation, to buy or sell shares of an underlying security at a specific price for a specific time. Since the 1970's a number of exchanges have been formed, including the Chicago Board Options Exchange (the “CBOE”), the American Stock Exchange (the “AMEX”), the Pacific Stock Exchange (the “PCX”), the International Securities Exchange (the “ISE”), the Philadelphia Stock Exchange (the “PHLX”), and the Boston Options Exchange (the “BOX”). In general terms, four specifications describe an options contract: the type of the option (e.g., a put or a call), the premium (or the initial amount paid on the contract), the underlying security (or the security, such as an equity, which must be delivered or purchased if the option is exercised), and a contract expiration date.

Unlike other exchange-traded securities, which can generally be traded on equal terms at any exchange, many options trade differently at different exchanges. The variations can include differences in price, execution time, liquidity, etc. For example, an option whose underlying security is IBM Corp. stock may be traded on several exchanges, however, there may be slightly different order pricing and execution characteristics associated with trades at different exchanges. IBM options at the ISE, for example, may be trading at the National Best Bid and Offer (“NBBO”—a dynamically updated price which shows a security's highest bid and lowest offer among all exchanges and market makers registered to trade in that security), while IBM options at the AMEX may be slightly higher than the NBBO.

Typically, at any given time during the trading day, each exchange has a book of limit orders on each transaction side (bid and asked) for each option traded on the exchange. Each limit order on the book is defined by two parameters—price and size—in addition to side. If a market order comes in to the exchange that is equal to or smaller in size than the best limit order on the book, the market order may be filled from the best limit order on the book. If the market order exceeds the size of the best limit order on the book, the market order may be partially filled by the best limit order, and the balance of the market order may be filled by the next limit order on the book, so that the entire market order may not receive the price of the best limit order.

To help to provide orderly and favorable handling of orders, each of the exchanges referred to above has adopted the practice of publishing an “automatic execution” or “auto ex” order size for each option traded on the exchange. If a market order is sent to a particular exchange and has an order size less than or equal to the auto ex order size for the option in question on the exchange, the market order is assured of immediate execution at the currently quoted price.

Customers generally expect to have their market orders executed rapidly and at the best possible price. It may be difficult to satisfy this expectation in the case of large orders, which may be delayed in execution and/or which upon being sent to an exchange may push the price away from the price quoted at the time the order was placed. It would be desirable to provide an options system which addresses deficiencies associated with existing option systems.

### SUMMARY

To alleviate problems inherent in the prior art, embodiments of the present invention introduce systems, methods, apparatus, computer program code and means for routing transactions. According to some embodiments, a first options trading order is determined. The first options trading order is to be forwarded to at least one order execution destination and identifies an option to be traded and a first order size. A plurality of current price quotations are received for the option, with each of the quotations being from a respective one of a first plurality of order execution destinations. A second plurality of order execution destinations are determined. Each of the second plurality of order execution destinations matches a current best price for the option identified by the first options trading order and each of the second plurality of order execution destinations has a currently published automatic execution order size for the option identified by the first options trading order. The second plurality of order execution destinations is included in the first plurality of order execution destinations. The first options trading order is divided into a plurality of second options trading orders. Each of the second options trading orders has an order size and corresponds to a respective one of the second plurality of order execution destinations. The step of dividing the first options trading order into the second options trading orders includes setting the respective order size of at least one of the second options trading orders to match the respective automatic execution order size published, for the option identified by the first options trading order, by the respective order execution destination that corresponds to the second options trading order or orders.

As used herein and in the appended claims, “order execution destination” refers to any venue, including an options or securities exchange or an electronic network, at which options are now or hereafter traded.

Systems, methods, apparatus, computer program code and means are provided for dividing a first options trading order among a plurality of order execution destinations in accordance with respective automatic execution order sizes published by the order execution destinations for an option identified by the first options trading order.

Systems, methods, apparatus, computer program code and means for processing option orders are also provided where a first options trading order is divided among a plurality of order execution destinations based at least in part on respective automatic execution order sizes published by the order execution destinations for an option identified by the first options trading order.

In addition, systems, methods, apparatus, computer program code and means are provided for receiving a first options trading order which identifies an option to be traded and a first order size and for dividing the first options trading order into a plurality of secondary options trading orders. Each of the secondary options trading orders identifies the option to be traded. The plurality of second options trading orders include a first secondary options trading order directed to a first order execution destination and having an order size that matches an automatic execution order size that is currently published by the first order destination for the option identified by the first options trading order; a second secondary options trading order directed to a second order execution destination and having an order size that matches an automatic execution order size that is currently published by the second order destination for the option identified by the first options trading order; a third secondary options trading order directed to a third order execution destination and having an order size that matches an automatic execution order size that is currently published by the third order destination for the option identified by the first options trading order; a fourth secondary options trading order directed to a fourth order execution destination and having an order size that matches an automatic execution order size that is currently published by the fourth order destination for the option identified by the first options trading order; and a fifth secondary options trading order directed to a fifth order execution destination and having an order size that exceeds an automatic execution order size that is currently published by the fifth order execution destination for the option identified by the first options trading order.

As used herein and in the appended claims, “secondary options trading order” refers to an order placed with an order execution destination to fulfill a portion of an options trading order received from a customer or generated by a broker for its own account.

Further, systems, methods, apparatus, computer program code and means are provided for dividing a first options trading order among a plurality of order execution destinations. The first options trading order identifies an option to be traded. Each order execution destination has a published automatic execution order size for the option identified by the first options trading order. Respective portions of the first options trading order are (first) allocated to each of the order execution destinations in a respective amount that matches the published automatic execution order size of the order execution destination in question. At least one additional respective portion of the first options trading order is (second) allocated to at least one of the order execution destinations that has a respective displayed order size that exceeds the respective published automatic execution order size for the order execution destination in question. The at least one additional portion corresponds to the excess of the respective displayed order size over the respective published automatic execution order size for the respective order execution destination. The balance of the first options trading order is then (third) allocated to a selected one of the order execution destinations. A respective secondary options trading order is placed with each of the order execution destinations, in accordance with the allocating steps.

Moreover, systems, methods, apparatus, computer program code and means are provided for receiving a first options trading order. The first options trading order identifies an option to be traded and has a first size. A plurality of order execution destinations are identified. Each of the identified order execution destinations currently offers a price for the option that matches a current best price for the option, and has a published automatic execution order size for the option. A respective secondary order is sent to each of the identified order execution destinations, Each of the secondary orders has a size that is at least equal to the published automatic execution order size of the respective order execution destination.

Also, systems, methods, apparatus, computer program code and means are provided for receiving a first options trading order. The first options trading order identifies an option to be traded and has a first size. A plurality of order execution destinations are identified. Each of the identified order execution destinations currently offers a price for the option that matches a current best price for the option, and has a published automatic execution order size for the option. A respective secondary order is sent to each of the identified order execution destinations. Each of the secondary orders has a size that does not exceed the published automatic execution order size of the respective order execution destination.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 is a block diagram of a system consistent with the present invention;

FIG. 2 is a block diagram of one embodiment of a routing system for use in conjunction with the system of FIG. 1;

FIG. 3 is a flow diagram illustrating an exemplary process for routing option orders pursuant to one embodiment of the present invention;

FIG. 4 is a flow diagram illustrating a further exemplary process for routing option orders pursuant to one embodiment of the present invention;

FIG. 5 is a table showing an example set of quotations used to illustrate an exemplary operation of an embodiment of the present invention; and

FIG. 6 is a table showing an example routing scenario provided by an embodiment of the present invention based on the quotations of FIG. 5.

### DETAILED DESCRIPTION

Applicants have recognized that there is a need for an improved system, method, apparatus, computer program code, and means for routing transactions. More particularly, Applicants have recognized that there is a need for an improved system, method, apparatus, computer program code and means for dividing options trade requests among options exchanges in a manner which promotes timely execution of the trade requests at the best available price.

For the purposes of describing features of embodiments of the present invention, a number of terms are used herein. For example, the term “option” is used to refer to a contract which gives a buyer the right, but not the obligation, to buy or sell shares of the underlying security or index at a specific price for a specified time. In the description presented herein, the underlying securities described are equity securities or “stocks”. Stock option contracts generally are for 100 shares of the underlying stock.

As used herein, the terms “exchange” or “options exchange” are used to refer to any securities exchange which lists and facilitates the trading of options. For example, currently in the U.S., listed options are traded on the following national securities exchanges: AMEX, BOX, CBOE, ISE, PCX and PHLX. Embodiments of the present invention may be used to route and facilitate trading of options on other exchanges as well (including non-U.S. exchanges), and the terms “exchange” or “options exchange” are not intended to be limited to the above-identified exchanges.

As used herein, the term “specialist” includes registered competitive market makers, specialists, primary market makers and other registered securities dealers which maintain firm bids and offers by standing ready to buy or sell contracts of securities and which announce their pricing throughout the day.

In general, and for the purposes of introducing concepts of embodiments of the present invention, option orders may be processed as follows. A customer (directly or through a broker, for example), or a broker acting for its own account, creates an option order and forwards the order to a trading system for execution. The trading system, pursuant to embodiments of the present invention, is in communication with an order routing system configured to route orders to various exchanges. If the order is relatively large, the routing system may operate to divide the order among various exchanges. The exchanges which are currently offering the best price (NBBO) are identified, and a portion of the order which matches the exchange's auto ex size for the option is allocated to each of the identified exchanges. If the order is not exhausted by the first allocation, then an additional allocation of the order may be made. The additional allocation may be based on a displayed best order size at one or more of the identified exchanges that exceeds the auto ex size at the exchange in question. If this second allocation does not exhaust the order, then a third allocation may be made to a selected one of the identified exchanges. Secondary orders are then placed to the identified exchanges based on the allocations. This approach may maximize the opportunities for immediate execution of a large order at the most favorable price, by taking full advantage of the auto ex sizes of the exchanges which currently match the NBBO.

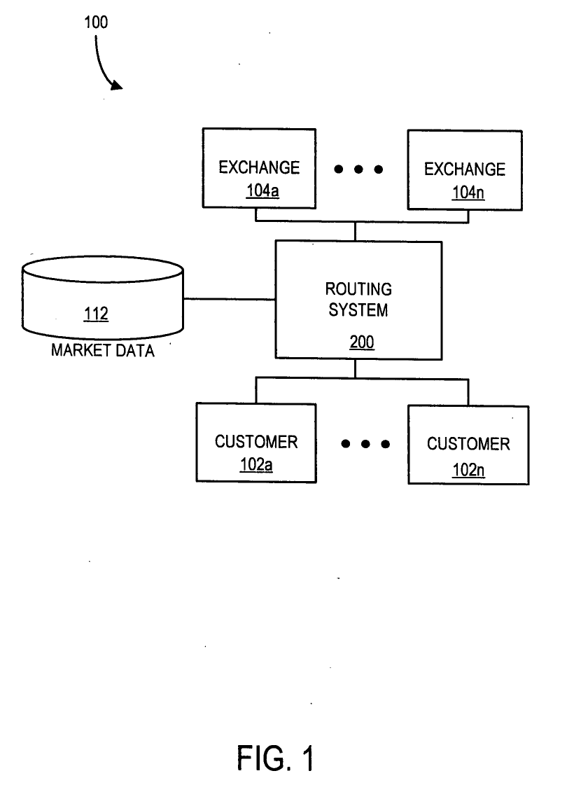

Embodiments of the present invention will now be described by first referring to FIG. 1 where a block diagram of one embodiment of a trading system 100 is shown. As shown, trading system 100 includes a number of different components which cooperatively operate to process and route option orders pursuant to some embodiments of the present invention. As depicted, trading system 100 includes a routing system 200 in communication with a number of customers 102a-n, a number of exchanges 104a-n, and one or more sources of market data 112. In a typical implementation, trading system 100 may also include an execution core (not shown). Customer orders are submitted to the execution core where they are entered into the broker's system, timestamped, and assigned an order number. Routing system 200, in some embodiments, interacts with the execution core to process customer orders. Any of a number of execution cores may be used, such as, for example, the Redi® system offered by Spear, Leeds & Kellogg (a division of Goldman Sachs & Co.). Other execution cores may also be used in conjunction with the routing system of the present invention.

Although a single routing system 200 is shown in FIG. 1, any number of these devices may be included in trading system 100. Similarly, any number of market data sources 112, customer devices 102, exchange devices 104 or any other device described herein may be included in the trading system 100 according to some embodiments of the present invention.

Each of the devices of system 100 may be formed of devices capable of performing the various functions described herein. For example, a customer device 102 may be a computing device such as a Personal Computer (PC), a laptop, a telephone, or other device associated with a “customer.” As used herein, the term “customer” may refer to, for example, an individual or other entity that buys and sells securities (and, pursuant to some embodiments of the present invention, options). For example, a customer operating a customer device 102 may be a broker or other entity desiring to purchase or sell options using features of embodiments of the present invention. The broker or other entity may be operating on behalf of the ultimate purchaser of the securities.

An exchange device 104 may be any computing device(s) operated by or on behalf of one or more securities exchanges. In one particular embodiment, exchange devices 104 are devices operated by or on behalf of exchanges which facilitate the trade of options. For the purposes of describing features of embodiments of the present invention, the six U.S. exchanges identified above will be referenced herein. Each of these exchanges may be in communication with other devices described herein using techniques known in the art. For example, the six U.S. exchanges are in communication with a central entity (the Options Clearing Corporation, or “OCC”) which acts as a central clearing organization to process option contract trades. In general, the OCC receives information from the exchanges after the completion of trades, and operates to ensure trades are completed and settled pursuant to their terms.

Each exchange device 104 may include one or more operator terminals allowing specialists or traders at the exchange to respond to option orders received and to complete an option order pursuant to its terms.

According to some embodiments of the present invention, a relatively large option order received by routing system 400 may be divided among several exchanges for execution, according to one or more allocation processes as described below. A relatively small order may be sent to a single exchange for execution. Selection of the single exchange may be done in accordance with one or more routing rules, as described, for example in U.S. published patent application US 2003/0177082, which is commonly assigned herewith. For example, an option order to purchase 50 contracts of IBM call options may be routed to either the CBOE, the ISE, or the PHLX, depending on the routing rules applied to the option order. An option order to purchase 500 contracts of IBM call options may divided among four or five or even all six exchanges, as described below, to take maximum advantage of auto ex sizes published for IBM options by the exchanges.

Sources of market data 112 may be any of a number of different types of options market data received from a variety of data sources and which can be used to facilitate option transactions. For example, in the U.S., intra-day option pricing data is provided by the Option Price Reporting Authority (OPRA). In some embodiments, market data 112 includes a feed of OPRA data. In some embodiments, this OPRA data feed is received by routing system 200 substantially in real-time. This OPRA data feed provides option pricing from each of the options exchanges in the U.S. Those skilled in the art will recognize that other types of market data sources may also be used to assist in the processing and routing of transactions as described herein. In some embodiments, this pricing data is retrieved on an as-needed basis (e.g., when a routing decision is being made, a price inquiry may be presented to a particular specialist to identify the specialist's current pricing for the particular option being routed).

Routing system 200 may also be any computing device which is capable of performing the various functions described herein. For example, in some embodiments, routing system 200 may be configured as a Web server adapted to exchange information with customer devices 102, exchanges 104 and sources of market data 112. As used herein, devices (e.g., routing system 200, customer devices 102, exchanges 104 and market data sources 112) may communicate, for example, via one or more communication networks. For example, some or all of the devices may be in communication via an Internet Protocol (IP) network such as the Internet. Some or all of the devices may be in communication via other types of networks such as an intranet, a Local Area Network (LAN), a Metropolitan Area Network (MAN), a Wide Area Network (WAN), a proprietary network, a Public Switched Telephone Network (PSTN), and/or a wireless network.

According to some embodiments of the present invention, routing system 200 communicates with the customer devices 102, exchanges 104 and sources of market data 112 via a temporary computer communication channel (e.g., a logic path through which information can be exchanged). In other words, the communication channel between routing system 200 and other devices may be established and discontinued as appropriate. For example, routing system 200 may exchange information with a customer device 102a via a Web site (e.g., when a browser application executing on the customer device 102a is accessing the Web site to place an option trade request).

According to some embodiments, routing system 200 communicates with other devices via a public computer communication network. That is, at least a portion of the communication network may be accessed by devices other than routing system 200 and the other devices depicted in FIG. 1. Note, however, that the information exchanged between routing system 200 and other devices of FIG. 1 may be encrypted or otherwise protected to prevent a third party from accessing, manipulating, understanding and/or misusing the information.

According to an embodiment of the present invention, routing system 200 receives option order information from customer devices 102. As used herein, the term “option order” is used to refer to orders involving offers to purchase or sell securities commonly known as “options”. An option order may also be referred to as an “options trading order”. As used herein, each option order includes a number of terms defining the offer to purchase or sell. For example, an option order may include a customer identifier (identifying the party offering to purchase or sell), a symbol (identifying the security associated with the option order), an amount or size of the order (identifying the number, typically in lots of 100, of options desired to be purchased or sold). Each option order may also include information identifying a type of the order. For example, the option order may be immediately executable (e.g., be a market or marketable limit order), or it may have special conditions or instructions associated with the order. Finally, each order may also include information identifying an expiration date of the option contract.

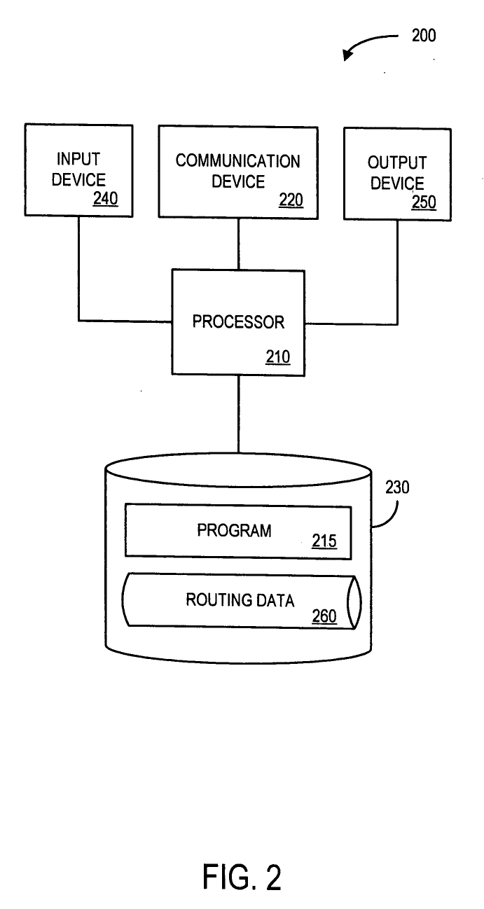

Reference is now made to FIG. 2 where an embodiment of routing system 200 is shown. As depicted, routing system 200 includes a computer processor operatively coupled to a communication device 220, a storage device 230, an input device 240 and an output device 250. Communication device 220 may be used to communicate, for example, with other devices (such as user devices 102, exchanges 104 and sources of market data 112). Input device 240 may comprise, for example, a keyboard, a mouse or other pointing device, a microphone, knob or a switch, an IR port, a docking station, and/or a touch screen. Input device 240 may be used, for example, to enter information (e.g., information to select a preferred exchange or to indicate priorities among exchanges). Output device 250 may comprise, for example, a display (e.g., a display screen), a speaker, and/or a printer.

Storage device 230 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

Storage device 230 stores one or more programs 215 for controlling processor 210. Processor 210 performs instructions of program 215, and thereby operates in accordance with the present invention.

Storage device 230 may also store databases, including, for example, a database 260 for data used to make decisions about how to divide up large orders. The data may include data that indicates preferences among exchanges as selected by the broker, customer or proprietor of the trading system 100.

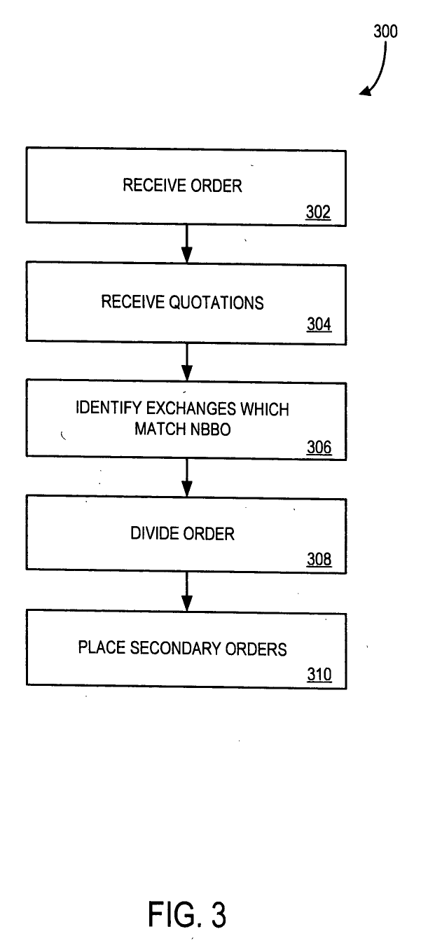

Operation of some embodiments of the present invention will now be described by referring to FIG. 3 where a process 300 is shown for dividing up a large options trading order pursuant to one embodiment of the present invention. The flow chart in FIG. 3 and the flow charts in other figures described herein do not imply a fixed order to the steps, and embodiments of the present invention can be practiced in any order that is practicable. Some or all of the steps of the process shown in FIG. 3 may be performed, for example, by, or on behalf of, a trading entity or service provider operating routing system 200 in conjunction with other devices.

Process 300 begins at 302 where a customer options trading order is received. (Alternatively, the order may be generated for its own account by an entity which operates the routing system 200. Either receiving a customer order or generating an order for one's own account may be referred to as “determining” an order.) In some embodiments, customer option trading orders may be submitted directly from user devices 102 to routing system 200. Orders may be submitted in batch files (e.g., with multiple trade requests) or individually. Each order may include details of the order, including: an identification of the customer, an identification of the underlying security to be purchased or sold, an identification of whether the order is a bid or an ask, and the size of the order. Other terms may also be provided (e.g., such as an identification of whether the order is a market or limit order or the like).

Before, at the same time, or shortly after a customer order has been received by the routing system 200, the routing system 200 may operate, as indicated at 304, to access or receive quotation information that indicates current price quotations available for the option in question at each of the exchanges. Processing continues at 306 to identify the exchanges which currently have quotations that match the NBBO. Then, at 308, the customer order is divided among the exchanges identified at 306 as currently matching the NBBO. As will be appreciated from subsequent discussion, the division of the customer order is based at least in part on the auto ex sizes for the option in question at the identified exchanges. Thus, at least some exchanges are to receive orders that match their auto ex sizes for the option. Secondary orders are then placed at the identified exchanges, as indicated at 310, to implement the division of the customer orders as provided at 308.

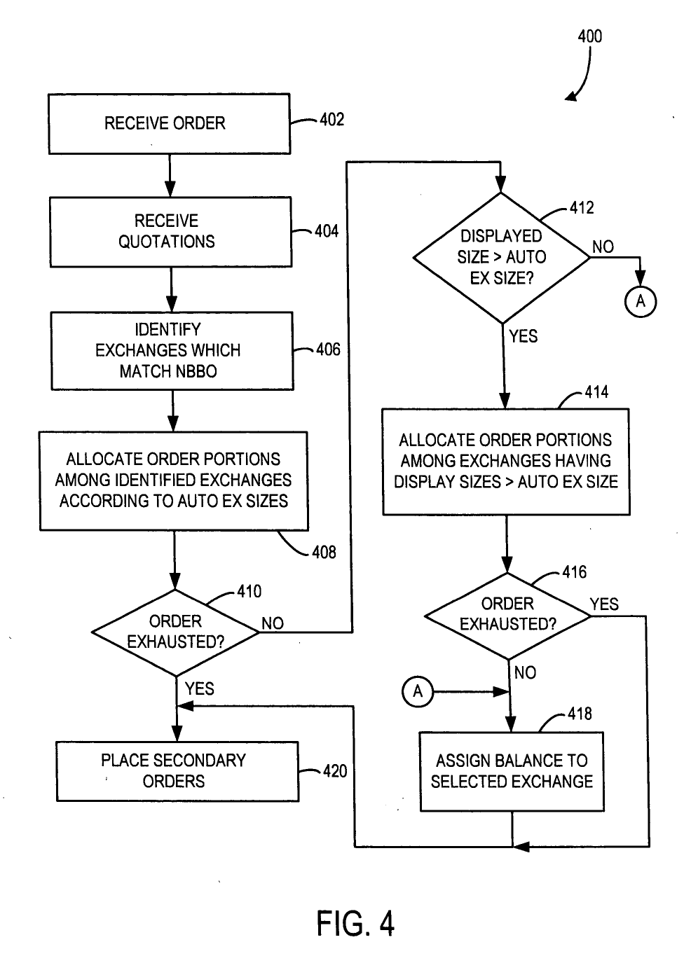

Further details of some embodiments of the present invention will now be described by referring to FIG. 4 where a transaction process 400 is shown. Process 400 may be performed by routing system 200 in conjunction with other devices shown in FIG. 1. Processing begins at 402 where a customer option order is received by routing system 200 (e.g., via the Internet, via telephone or the like). (Alternatively, the order may be generated for its own account by an entity which operates the routing system 200. Either receiving a customer order or generating an order for one's own account may be referred to as “determining” an order.) The customer option order includes information identifying the terms of a desired option transaction. It will be assumed for the purposes of this example that the customer order is either a market order or a marketable limit order. It will also be assumed that the size of the order is such that it may be advisable to divide the order to obtain immediate execution at the best price.

Processing continues at 404 where the routing system 200 accesses and/or receives quotations from all of the options exchanges to determine current order prices and sizes on the books of the exchanges. Processing continues at 406, where the routing system 200 determines from the quotations which of the exchanges currently match the NBBO. The exchanges which currently match the NBBO are identified as candidates to receive portions of the customer order.

Processing continues at 408, where the trading system 200 allocates portions of the customer order among the exchanges identified at 406. The portion allocated to each exchange at this point is no more than the published auto ex size for the exchange for the option in question. The allocation at 408 may proceed among the exchanges in an order of preference that has been established for the exchanges by, e.g., the proprietor of the routing system 200.

At a decision block 410, it is determined whether the customer order has been exhausted (fully allocated) by allocations among the qualifying (best price matching) exchanges up to the respective auto ex sizes of the qualifying exchanges. If a negative determination is made at 410 (i.e., if it is determined that the customer order was not exhausted at 410), it is next determined at decision block 412, for each qualifying exchange, whether the exchange is currently displaying a size of its best book order for the option in question which exceeds the auto ex size for that exchange for that option. If there are such exchanges, a further allocation is made, as indicated at 414, to one or more of such exchanges in an amount up to the excess of the displayed size over the auto ex size. Again, the allocation at 414 may be made in order among exchanges that meet the test of 412 in accordance with an order of preference established by the proprietor of the routing system.

Next, at 416, it is again determined whether the customer order has been exhausted by the allocations made up to this point. If such is not the case, then processing may continue at 418, where a final allocation of the balance of the order may be made to a selected (e.g., a most preferred) exchange. Processing continues at 420, where the allocations made to each particular qualifying exchange are aggregated to form a secondary order to be sent to the qualifying exchange, and the resulting secondary orders are then sent to the qualifying exchanges.

In the event that a positive determination (exhaustion of the customer order) is made at either of the decision blocks 410 or 416, then the processing at 420 immediately follows the decision block 410 or 416, as the case may be.

In the event that a negative determination is made at decision block 412 as to all qualifying exchanges (i.e., no qualifying exchange has a displayed order size greater than its auto ex size), then the processing at 418 immediately follows decision block 418, followed by the processing at 420.

There will next be described specific examples and scenarios in accordance with which the process 400 may be performed, depending on particular order characteristics and varying market conditions.

For a first example and scenario, assume that the following customer order is received at 402: “Buy 500 XYZ JAN 50 calls”. In this case “XYZ” refers to a fictitious underlying security (common stock) which is assumed to be real for present purposes. “500” is the size of the customer order (i.e., the number of contracts to be bought). “JAN” specifies the expiration date of the options to be acquired, and “50” specifies the strike price.

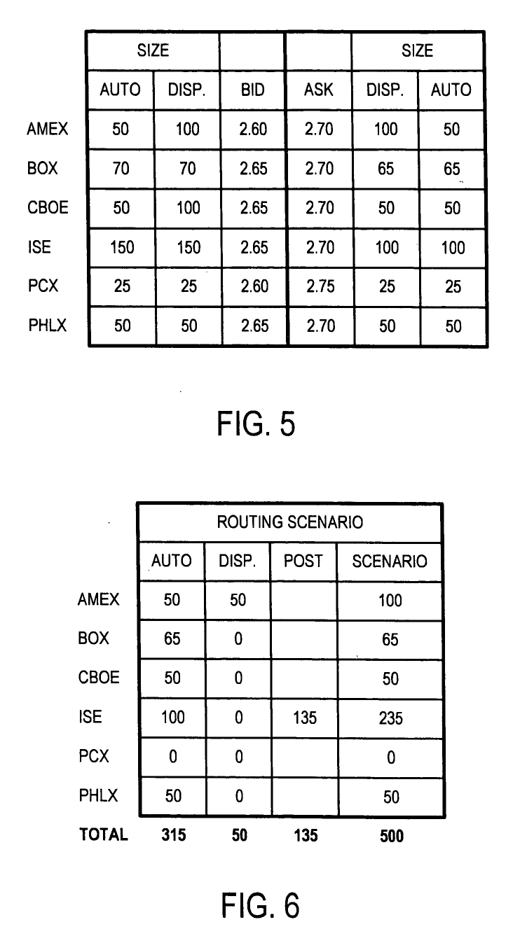

Current quotes for the option are then obtained, if the information is not already on hand. For the purposes of this example, it will be assumed that the quotes are as indicated in FIG. 5. An examination of the quotes for the buy side indicates that the current NBBO is $2.70 and that AMEX, BOX, CBOE, ISE and PHLX currently match the NBBO. It will further be assumed that the order of preference of these exchanges has previously been set as follows: ISE, AMEX, BOX, CBOE, PHLX. Consequently, as indicated in FIG. 6, of the order size of 500, 100 contracts are initially allocated to ISE, 50 contracts are initially allocated to AMEX, 65 contracts are initially allocated to BOX, 50 contracts are initially allocated to CBOE, and 50 contracts are initially allocated to PHLX. In each case, the number of contracts initially allocated to the qualifying exchange is equal to the auto ex size of the exchange. At this point 315 of the 500 contracts have been allocated.

The displayed size for AMEX is 100, which is in excess of the auto ex size of 50 for AMEX. Accordingly, another 50 contracts are now allocated to AMEX, leaving an unallocated balance of 135 contracts. These contracts may then be allocated to a preferred one of the exchanges, assumed in this case to be ISE. (An exchange may be selected to be preferred because, e.g., it has been found to provide the most liquidity, best and/or fastest execution, etc.)

The outcome of this routing scenario is that a secondary order for 235 contracts is sent to ISE, a secondary order for 100 contracts is sent to AMEX, a secondary order for 65 contracts is sent to BOX, a secondary order for 50 contracts is sent to CBOE, and a secondary order of 50 contracts is sent to PHLX. It will be noted that the orders to BOX, CBOE and PHLX match the auto ex sizes of those exchanges for the option in question. The order to AMEX matches the currently displayed size for the option at AMEX which is in excess of the AMEX auto ex size for the option. The order to ISE exceeds both the auto ex and currently displayed sizes for ISE.

In this way the customer order of 500 contracts is divided up in a way that takes into account the auto ex sizes of the various exchanges which currently match the NBBO. As a result, the opportunity for immediate execution at the best current price is maximized.

Assume next that the size of the customer order in the previous example had been 150 rather than 500. In such a case, a secondary order for 100 contracts would be sent to ISE, matching the auto ex size for the option on the ISE; and a secondary order for 50 contracts would be sent to AMEX, matching the auto ex size for the option on the AMEX.

Next it will be assumed that the size of the customer order in the previous example is 200 rather than 500. In such a case, a secondary order for 100 contracts would be sent to ISE, matching the auto ex size for the option on the ISE; a secondary order for 50 contracts would be sent to AMEX, matching the auto ex size for the option on the AMEX; and a secondary order for 50 contracts would be sent to BOX, being less than the auto ex size for the option on the BOX.

Next assume that the size of the customer order is 350 rather than 500. In such a case, a secondary order for 100 contracts would be sent to ISE, matching the auto ex size for the option on the ISE; a secondary order for 85 contracts would be sent to AMEX, being in excess of the auto ex size for the option on the AMEX (though less than the displayed size); a secondary order for 65 contracts would be sent to BOX, matching the auto ex size for the option on the BOX; a secondary order for 50 contracts would be sent to the CBOE, matching the auto ex size for the option on the CBOE; and a secondary order for 50 contracts would be sent to PHLX, matching the auto ex size for the option on the PHLX.

To provide yet another example, assume the situation is as in the first example, with a customer order size of 500, but that the currently displayed size for AMEX is 50 rather than 100. In such a case, a secondary order for 285 contracts would be sent to ISE, exceeding the auto ex size for the option on the ISE; a secondary order for 50 contracts would be sent to AMEX, matching the auto ex size for the option on the AMEX; a secondary order for 65 contracts would be sent to BOX, matching the auto ex size for the option on the BOX; a secondary order for 50 contracts would be sent to the CBOE, matching the auto ex size for the option on the CBOE; and a secondary order for 50 contracts would be sent to PHLX, matching the auto ex size for the option on the PHLX.

In some embodiments, the allocation algorithm illustrated in FIG. 4 may be changed, but may still take into account the respective auto ex sizes of at least some of the exchanges that currently match the NBBO.

In rare cases, an exchange may have a public offer sitting on top of the book with a size that is less than the auto ex size. To deal with such a case, the routing system 200 may operate to limit the secondary order to that exchange to the size of the order on top of the book, but may take the auto ex sizes of other exchanges into account in setting the sizes of secondary orders to the other exchanges.

Although the present invention has been described with respect to a preferred embodiment thereof, those skilled in the art will note that various substitutions may be made to those embodiments described herein without departing from the spirit and scope of the present invention.

What is claimed is:

1. A method comprising:
determining a first options trading order to be forwarded to at least one order execution destination, the first options trading order identifying an option to be traded and a first order size;
receiving a plurality of current price quotations for said option, each of the quotations from a respective one of a first plurality of order execution destinations;
determining a second plurality of order execution destinations, each matching a current best price for the option identified by the first options trading order and currently having a published automatic execution order size for the option identified by the first options trading order, the second plurality of order execution destinations included in the first plurality of order execution destinations; and
dividing the first options trading order into a plurality of second options trading orders, each of the second options trading orders having an order size and corresponding to a respective one of the second plurality of order execution destinations, wherein the dividing includes setting the respective order size of at least one of the second options trading orders to match the respective automatic execution order size published, for the option identified by the first options trading order, by the respective order execution destination that corresponds to said at least one of the second options trading orders.

2. The method of claim 1, wherein none of the respective order sizes of the second options trading orders exceeds the respective automatic execution size published, for the option identified by the first options trading order, by the respective order execution destination that corresponds to each of the second options trading orders.

3. The method of claim 1, wherein one of the second options trading orders has an order size that exceeds the respective automatic execution size published, for the option identified by the first options trading order, by the respective order execution destination that corresponds to said one of the second options trading orders; and each of the other second options trading orders has an order size that exactly matches the respective automatic execution size published, for the option identified by the first options trading order, by the respective order execution destination that corresponds to said each of the other options trading orders.

4. The method of claim 1, further comprising:
placing each of said second options trading orders with its corresponding order execution destination.

5. The method of claim 1, wherein the step of determining the first options trading order includes receiving the first options trading order from a customer.

6. The method of claim 1, wherein at least some of the order execution destinations are securities exchanges.

7. The method of claim 6, wherein all of the order execution destinations are securities exchanges.

8. The method of claim 1, wherein the option identified by the first options trading order is an option to buy a common stock or an option to sell a common stock.

9. The method of claim 1, wherein a sum of respective order sizes of the second options trading orders equals said first order size.

10. A method comprising:
dividing a first options trading order among a plurality of order execution destinations in accordance with respective automatic execution order sizes published by the order execution destinations for an option identified by the first options trading order.

11. The method of claim 10, further comprising:
receiving the first options trading order from a customer prior to said dividing step.

12. The method of claim 10, further comprising:
placing a respective secondary options trading order with each of said plurality of order execution destinations based on a result of said dividing step.

13. The method of claim 12, wherein the first options trading order has a first size, and the secondary options trading orders each have a respective size, a sum of the sizes of the secondary options trading orders being equal to said first size.

14. The method of claim 13, wherein each of the sizes of the secondary options trading orders is equal to the respective automatic execution order size published, for said option identified by the first options trading order, by the respective order execution destination of the respective secondary options trading order.

15. The method of claim 13, wherein all except one of the sizes of the secondary options trading orders are each equal to the respective automatic execution order size published, for said option identified by the first options trading order, by the respective order execution destination of the respective secondary options trading order.

16. The method of claim 15, wherein said one of the sizes of the secondary options trading orders is smaller than the respective automatic execution size published, for said option identified by the first options trading order, by the respective order execution destination of the respective secondary options trading order.

17. The method of claim 15, wherein said one of the sizes of the secondary options trading orders exceeds the respective automatic execution size published, for said option identified by the first options trading order, by the respective order execution destination of the respective secondary options trading order.

18. The method of claim 10, wherein at least some of the order execution destinations are securities exchanges.

19. The method of claim 18, wherein all of the order execution destinations are securities exchanges.

20. The method of claim 10, wherein the option identified by the first options trading order is an option to buy a common stock or an option to sell a common stock.

21. A method comprising:
dividing a first options trading order among a plurality of order execution destinations based at least in part on respective automatic execution order sizes published by the order execution destinations for an option identified by the first options trading order.

22. The method of claim 21, further comprising:
receiving the first options trading order from a customer prior to said dividing step.

23. The method of claim 21, further comprising:
placing a respective secondary options trading order with each of said plurality of order execution destinations based on a result of said dividing step.

24. The method of claim 23, wherein the first options trading order has a first size, and the secondary options trading orders each have a respective size, a sum of the sizes of the secondary options trading orders being equal to said first size.

25. The method of claim 24, wherein each of the sizes of the secondary options trading orders is equal to the respective automatic execution order size published, for said option identified by the first options trading order, by the respective order execution destination of the respective secondary options trading order.

26. The method of claim 24, wherein all except one of the sizes of the secondary options trading orders are each equal to the respective automatic execution order size published, for said option identified by the first options trading order, by the respective order execution destination of the respective secondary options trading order.

27. The method of claim 26, wherein said one of the sizes of the secondary options trading orders is smaller than the respective automatic execution size published, for said option identified by the first options trading order, by the respective order execution destination of the respective secondary options trading order.

28. The method of claim 26, wherein said one of the sizes of the secondary options trading orders exceeds the respective automatic execution size published, for said option identified by the first options trading order, by the respective order execution destination of the respective secondary options trading order.

29. The method of claim 21, wherein at least some of the order execution destinations are securities exchanges.

30. The method of claim 29, wherein all of the order execution destinations are securities exchanges.

31. The method of claim 21, wherein the option identified by the first options trading order is an option to buy a common stock or an option to sell a common stock.

32. A method comprising:
receiving a first options trading order which identifies an option to be traded and a first order size; and
dividing said first options trading order into a plurality of secondary options trading orders, each of said secondary options trading orders identifying said option to be traded, said plurality of secondary options trading orders including:
a first secondary options trading order directed to a first order execution destination and having an order size that matches an automatic execution order size that is currently published by said first order execution destination for said option identified by said first options trading order;
a second secondary options trading order directed to a second order execution destination and having an order size that matches an automatic execution order size that is currently published by said second order execution destination for said option identified by said first options trading order;
a third secondary options trading order directed to a third order execution destination and having an order size that matches an automatic execution order size that is currently published by said third order execution destination for said option identified by said first options trading order;
a fourth secondary options trading order directed to a fourth order execution destination and having an order size that matches an automatic execution order size that is currently published by said fourth order execution destination for said option identified by said first options trading order; and
a fifth secondary options trading order directed to a fifth order execution destination and having an order size that exceeds an automatic execution order size that is currently published by said fifth order execution destination for said option identified by said first options trading order.

33. The method according to claim 32, wherein a sum of the respective order sizes of the first through fifth secondary options trading orders equals the first order size.

34. The method according to claim 32, wherein the order size of the fifth secondary options trading order exceeds a size of a best current book order of the fifth order execution destination for the option identified by said first options trading order.

35. The method of claim 32, further comprising:
placing the first secondary options trading order with the first order execution destination;
placing the second secondary options trading order with the second order execution destination;
placing the third secondary options trading order with the third order execution destination;
placing the fourth secondary options trading order with the fourth order execution destination; and
placing the fifth secondary options trading order with the fifth order execution destination.

36. The method of claim 32, wherein at least some of the order execution destinations are securities exchanges.

37. The method of claim 36, wherein all of the order execution destinations are securities exchanges.

38. The method of claim 32, wherein the option identified by the first options trading order is an option to buy a common stock or an option to sell a common stock.

39. A method of dividing a first options trading order among a plurality of order execution destinations, the first options trading order identifying an option to be traded, each order execution destination having a published automatic execution order size for said option identified by the first options trading order, the method comprising:
first allocating respective portions of the first options trading order to each of the order execution destinations in a respective amount that matches the published automatic execution order size of said each order execution destination;
second allocating at least one additional respective portion of the first options trading order to at least one of said order execution destinations that has a respective displayed order size that exceeds the respective published automatic execution order size for said at least one order execution destination, said at least one additional respective portion corresponding to an excess of said respective displayed order size over said respective published automatic execution order size for the respective order execution destination;
third allocating a balance of said first options trading order to a selected one of said order execution destinations; and
placing, in accordance with said first, second and third allocating steps, a respective secondary options trading order with each of said order execution destinations.

40. The method of claim 39, wherein each of the order execution destinations has a current quotation for said option identified by said first options trading order, all of said current quotations matching a best current price for said option.

41. The method of claim 39, wherein at least some of the order execution destinations are securities exchanges.

42. The method of claim 41, wherein all of the order execution destinations are securities exchanges.

43. The method of claim 39, wherein the option identified by the first options trading order is an option to buy a common stock or an option to sell a common stock.

44. A method comprising:
receiving a first options trading order, said first options trading order identifying an option to be traded and having a first size;
identifying a plurality of order execution destinations, each of the identified order execution destinations currently quoting a price for said option that matches a current best price for said option, each of the identified order execution destinations having a published automatic execution order size for said option; and
sending to each of the identified order execution destinations a respective secondary order that has a size at least equal to the published automatic execution order size of the respective identified order execution destination.

45. The method of claim 44, wherein a sum of the sizes of the secondary orders is equal to said first size.

46. The method of claim 44, wherein at least some of the order execution destinations are securities exchanges.

47. The method of claim 46, wherein all of the order execution destinations are securities exchanges.

48. The method of claim 44, wherein the option identified by the first options trading order is an option to buy a common stock or an option to sell a common stock.

49. The method of claim 44, wherein the identified order execution destinations include at least four order execution destinations.

50. The method of claim 49, wherein the size of each of at least three of the secondary orders is exactly equal to the respective automatic execution order size of the respective order execution destination.

51. A method comprising:
receiving a first options trading order, said first options trading order identifying an option to be traded and having a first size;
identifying a plurality of order execution destinations, each of the identified order execution destinations currently quoting a price for said option that matches a current best price for said option, each of the identified order execution destinations having a published automatic execution order size for said option; and
sending to each of the identified order execution destinations a respective secondary order that has a size that does not exceed the published automatic execution order size of the respective identified order execution destination.

52. The method of claim 51, wherein a sum of the sizes of the secondary orders is equal to said first size.

53. The method of claim 51, wherein at least some of the order execution destinations are securities exchanges.

54. The method of claim 53, wherein all of the order execution destinations are securities exchanges.

55. The method of claim 51, wherein the option identified by the first options trading order is an option to buy a common stock or an option to sell a common stock.

56. The method of claim 51, wherein the identified order execution destinations include at least four order execution destinations.

57. The method of claim 56, wherein the size of each of at least three of the secondary orders is exactly equal to the respective automatic execution order size of the respective order execution destination.

58. An apparatus comprising:
a processor; and
a storage device in communication with said processor and storing instructions adapted to be executed by said processor to:
determine a first options trading order to be forwarded to at least one order execution destination, the first options trading order identifying an option to be traded and a first order size;
receive a plurality of current price quotations for said option, each of the quotations from a respective one of a first plurality of order execution destinations;
determine a second plurality of order execution destinations, each matching a current best price for the option identified by the first options trading order and currently having a published automatic execution order size for the option identified by the first options trading order, the second plurality of order execution destinations included in the first plurality of order execution destinations; and
divide the first options trading order into a plurality of second options trading orders, each of the second options trading orders having an order size and corresponding to a respective one of the second plurality of order execution destinations, wherein the dividing includes setting the respective order size of at least one of the second options trading orders to match the respective automatic execution order size published, for the option identified by the first options trading order, by the respective order execution destination that corresponds to said at least one of the second options trading orders.

59. The apparatus of claim 58, further comprising:
a communication device coupled to said processor and adapted to communicate with at least one of a customer device and an exchange device.

60. An apparatus comprising:
a processor; and
a storage device in communication with said processor and storing instructions adapted to be executed by said processor to:
divide an options trading order among a plurality of order execution destinations in accordance with respective automatic execution order sizes published by the order execution destinations for an option identified by the options trading order.

61. The apparatus of claim 60, further comprising:
a communication device coupled to said processor and adapted to communicate with at least one of a customer device and an exchange device.

62. An apparatus comprising:
a processor; and
a storage device in communication with said processor and storing instructions adapted to be executed by said processor to:
divide an options trading order among a plurality of order execution destinations based at least in part on respective automatic execution order sizes published by the order execution destinations for an option identified by the options trading order.

63. The apparatus of claim 62, further comprising:
a communication device coupled to said processor and adapted to communicate with at least one of a customer device and an exchange device.

64. An apparatus comprising:
a processor; and
a storage device in communication with said processor and storing instructions adapted to be executed by said processor to:
receive a first options trading order which identifies an option to be traded and a first order size; and
divide said first options trading order into a plurality of secondary options trading orders, each of said secondary options trading orders identifying said option to be traded, said plurality of secondary options trading orders including:
a first secondary options trading order directed to a first order execution destination and having an order size that matches an automatic execution order size that is currently published by said first order execution destination for said option identified by said first options trading order;
a second secondary options trading order directed to a second order execution destination and having an order size that matches an automatic execution order size that is currently published by said second order execution destination for said option identified by said first options trading order;
a third secondary options trading order directed to a third order execution destination and having an order size that matches an automatic execution order size that is currently published by said third order execution destination for said option identified by said first options trading order;
a fourth secondary options trading order directed to a fourth order execution destination and having an order size that matches an automatic execution order size that is currently published by said fourth order execution destination for said option identified by said first options trading order; and
a fifth secondary options trading order directed to a fifth order execution destination and having an order size that exceeds an automatic execution order size that is currently published by said fifth order execution destination for said option identified by said first options trading order.

65. The apparatus of claim 64, further comprising:
a communication device coupled to said processor and adapted to communicate with at least one of a customer device and an exchange device.

66. An apparatus comprising:
a processor; and
a storage device in communication with said processor and storing instructions adapted to be executed by said processor to:
divide a first options trading order among a plurality of order execution destinations, the first options trading order identifying an option to be traded, each order execution destination having a published automatic execution order size for said option identified by the first options trading order, the dividing step comprising:
first allocating respective portions of the first options trading order to each of the order execution destinations in a respective amount that matches the published automatic execution order size of said each order execution destination;
second allocating at least one additional respective portion of the first options trading order to at least one of said order execution destinations that has a respective displayed order size that exceeds the respective published automatic execution order size for said at least one order execution destination, said at least one additional respective portion corresponding to an excess of said respective displayed order size over said respective published automatic execution order size for the respective order execution destination;
third allocating a balance of said first options trading order to a selected one of said order execution destinations; and
placing, in accordance with said first, second and third allocating steps, a respective secondary options trading order with each of said order execution destinations.

67. The apparatus of claim 66, further comprising:
a communication device coupled to said processor and adapted to communicate with at least one of a customer device and an exchange device.

68. An apparatus comprising:
a processor; and
a storage device in communication with said processor and storing instructions adapted to be executed by said processor to:
receive a first options trading order, said first options trading order identifying an option to be traded and having a first size;
identify a plurality of order execution destinations, each of the identified order execution destinations currently quoting a price for said option that matches a current best price for said option, each of the identified order execution destinations having a published automatic execution order size for said option; and
send to each of the identified order execution destinations a respective secondary order that has a size at least equal to the published automatic execution order size of the respective identified order execution destination.

69. The apparatus of claim 68, further comprising:
a communication device coupled to said processor and adapted to communicate with at least one of a customer device and an exchange device.

70. An apparatus comprising:
a processor; and
a storage device in communication with said processor and storing instructions adapted to be executed by said processor to:
receive a first options trading order, said first options trading order identifying an option to be traded and having a first size;
identify a plurality of order execution destinations, each of the identified order execution destinations currently quoting a price for said option that matches a current best price for said option, each of the identified order execution destinations having a published automatic execution order size for said option; and
send to each of the identified order execution destinations a respective secondary order that has a size that does not exceed the published automatic execution order size of the respective identified order execution destination.

71. The apparatus of claim 70, further comprising:
a communication device coupled to said processor and adapted to communicate with at least one of a customer device and an exchange device.

72. A medium storing instructions adapted to be executed by a processor to perform a method, said method comprising:
determining a first options trading order to be forwarded to at least one order execution destination, the first options trading order identifying an option to be traded and a first order size;
receiving a plurality of current price quotations for said option, each of the quotations from a respective one of a first plurality of order execution destinations;
determining a second plurality of order execution destinations, each matching a current best price for the option identified by the first options trading order and currently having a published automatic execution order size for the option identified by the first options trading order, the second plurality of order execution destinations included in the first plurality of order execution destinations; and
dividing the first options trading order into a plurality of second options trading orders, each of the second options trading orders having an order size and corresponding to a respective one of the second plurality of order execution destinations, wherein the dividing includes setting the respective order size of at least one of the second options trading orders to match the respective automatic execution order size published, for the option identified by the first options trading order, by the respective order execution destination that corresponds to said at least one of the second options trading orders.

73. A medium storing instructions adapted to be executed by a processor to perform a method, said method comprising:
dividing an options trading order among a plurality of order execution destinations in accordance with respective automatic execution order sizes published by the order execution destinations for an option identified by the options trading order.

74. A medium storing instructions adapted to be executed by a processor to perform a method, said method comprising:
dividing an options trading order among a plurality of order execution destinations based at least in part on respective automatic execution order sizes published by the order execution destinations for an option identified by the options trading order.

75. A medium storing instructions adapted to be executed by a processor to perform a method, said method comprising:
receiving a first options trading order which identifies an option to be traded and a first order size; and
dividing said first options trading order into a plurality of secondary options trading orders, each of said secondary options trading orders identifying said option to be traded, said plurality of secondary options trading orders including:
a first secondary options trading order directed to a first order execution destination and having an order size that matches an automatic execution order size that is currently published by said first order execution destination for said option identified by said first options trading order;
a second secondary options trading order directed to a second order execution destination and having an order size that matches an automatic execution order size that is currently published by said second order execution destination for said option identified by said first options trading order;
a third secondary options trading order directed to a third order execution destination and having an order size that matches an automatic execution order size that is currently published by said third order execution destination for said option identified by said first options trading order;
a fourth secondary options trading order directed to a fourth order execution destination and having an order size that matches an automatic execution order size that is currently published by said fourth order execution destination for said option identified by said first options trading order; and
a fifth secondary options trading order directed to a fifth order execution destination and having an order size that exceeds an automatic execution order size that is currently published by said fifth order execution destination for said option identified by said first options trading order.

76. A medium storing instructions adapted to be executed by a processor to perform a method of dividing a first options trading order among a plurality of order execution destinations, the first options trading order identifying an option to be traded, each order execution destination having a published automatic execution order size for said option identified by the first options trading order, the method comprising:
first allocating respective portions of the first options trading order to each of the order execution destinations in a respective amount that matches the published automatic execution order size of said each order execution destination;
second allocating at least one additional respective portion of the first options trading order to at least one of said order execution destinations that has a respective displayed order size that exceeds the respective published automatic execution order size for said at least one order execution destination, said at least one additional respective portion corresponding to an excess of said respective displayed order size over said respective published automatic execution order size for the respective order execution destination;
third allocating a balance of said first options trading order to a selected one of said order execution destinations; and
placing, in accordance with said first, second and third allocating steps, a respective secondary options trading order with each of said order execution destinations.

77. A medium storing instructions adapted to be executed by a processor to perform a method, said method comprising:
receiving a first options trading order, said first options trading order identifying an option to be traded and having a first size;
identifying a plurality of order execution destinations, each of the identified order execution destinations currently quoting a price for said option that matches a current best price for said option, each of the identified order execution destinations having a published automatic execution order size for said option; and
sending to each of the identified order execution destinations a respective secondary order that has a size at least equal to the published automatic execution order size of the respective identified order execution destination.

78. A medium storing instructions adapted to be executed by a processor to perform a method, said method comprising:
receiving a first options trading order, said first options trading order identifying an option to be traded and having a first size;
identifying a plurality of order execution destinations, each of the identified order execution destinations currently quoting a price for said option that matches a current best price for said option, each of the identified order execution destinations having a published automatic execution order size for said option; and
sending to each of the identified order execution destinations a respective secondary order that has a size that does not exceed the published automatic execution order size of the respective identified order execution destination.
